(19) United States
(12) Patent Application Publication
(10) Pub. No.: US 2014/0086593 A1
(43) Pub. Date: Mar. 27, 2014

(54) PHASE LOCKED LOOP

(71) Applicant: University of New Brunswick, Fredericton (CA)

(72) Inventor: Anthony BROWN, Fredericton (CA)

(21) Appl. No.: 14/096,698

(22) Filed: Dec. 4, 2013

Related U.S. Application Data
(63) Continuation of application No. 12/602,141, filed on Nov. 27, 2009.

(51) Int. Cl. H01S 3/10

(52) U.S. Cl. CPC H01S 3/10053
USPC 398/141; 372/29.011

(57) ABSTRACT

An optical phase-locked loop (OPLL) comprising a phase-frequency detector; first and second lasers; a local oscillator; a detector and a low pass filter connected in a circuit comprising a feedback path. The OPLL can also include a pre-scaler, a second local oscillator and a mixer.

### CROSS-REFERENCE TO RELATED APPLICATIONS

This application is a continuation of U.S. application Ser. No. 12/602,141, filed on Nov. 27, 2009 (currently pending), which is incorporated herein by reference in its entirety. U.S. application Ser. No. 12/602,141 is a national stage of International Application Number PCT/CA2009/001718, filed Nov. 26, 2009 (now expired), which is incorporated herein by reference in its entirety.

### FIELD

The present invention relates to phase locked loops (PLL).

### BACKGROUND

The optical phase locked loop (OPLL) generating radio or microwave signals using lasers has been the subject of research for some time. Phase locking of an optical oscillator is a key requirement of implementing coherent optical receivers that are necessary for advanced signaling techniques such as phase-shift keying (PSK), frequency-shift keying (FSK), and quadrature amplitude modulation (QAM). They also may be used to make more sensitive receivers for intensity modulated signals. Additionally, phase locked lasers form the heart of Brillouin Analysis-based distributed sensor systems.

Early work focused on locking spectrally pure (i.e. having a very narrow linewidth) solid state lasers such as the Nd:YAG laser. Solid state lasers, however, tend to be very expensive. They also often operate at wavelengths that are non-ideal. For instance, Nd:YAG lasers operate at a wavelength of 1319 nm, as opposed to the 1550 nm band which is preferred for long distance optical communication in optical fibre. Recently, fibre laser technology has matured to the point where lasers are available in the 1550 nm band that combine high power with stability approaching that of other solid state lasers. Although they are less expensive than older solid state technology, fibre lasers are still many times more expensive than semiconductor lasers.

The lowest cost laser technology is the semiconductor laser and it would seem that any low cost OPLL would need to be based on semiconductor lasers. Semiconductor lasers, however, are far less spectrally pure than their other solid state counterparts. In the language of PLLs they are said to have very high phase noise. In optical terms, they are said to have a large linewidth, (Δν). This has historically been a limiting factor for implementing an OPLL since spectrally impure (or high phase noise) sources are difficult or impossible to phase lock.

A PLL is a control system in which the phase of a tunable oscillator (usually a voltage controlled oscillator or VCO) is measured and compared (using a phase detector) to a stable reference oscillator. Any trend towards variation in phase of the VCO relative to the reference generates a correction signal that is low-pass filtered (by a loop filter) and the resulting signal is used to adjust the phase of the VCO. The reference oscillator generally has high long-term stability and a fixed frequency. In simple terms, the action of the PLL is to transfer the long-term stability of the reference oscillator to the VCO. The frequency of the VCO need not be the same as that of the reference since the phase detector can be used to compare fractions of the two oscillator frequencies. For instance, if the VCO frequency is divided by N and compared to the reference itself divided by R, the VCO output frequency will be exactly N/R times the reference frequency. The VCO can then be tuned, usually by altering the value of the divisor N.

As an oscillator, a laser is generally considered to have high relative stability, that is the variation in frequency as a fraction of the carrier frequency is very small. This is primarily because of the high carrier frequency. For example, a 1550 nm laser has a carrier frequency of over 193 THz. A typical linewidth for a semiconductor laser is 1 MHz, giving an excellent relative stability of about 5 parts per billion. When a pair of such lasers are mixed together in an OPLL to generate a 10 GHz microwave signal, however, the linewidth of the 10 GHz signal is approximately the summed linewidth of the two lasers (2 MHz), giving a very poor relative stability of only 200 parts per million.

The laser linewidth is itself a measure of the temporal stability of the laser. From the linewidth, the coherence time τ_{c} is defined as:

$${τ}_{c} \geq \frac{1}{4 π Δ v}$$

and may be considered as the length of time over which the laser output is predictable. For a 1 MHz linewidth laser, this results in a coherence time of about 80 ns. In order for an OPLL to maintain lock, the feedback signal has to be determined and applied within some small fraction of τ_{c}. The total time required for the PLL to measure the phase error and apply any necessary correction is known as the loop delay.

In conventional PLLs the primary parameter of concern in the control loop is the loop bandwidth. The action of the PLL is to suppress phase changes that occur at frequencies within the loop bandwidth by adjusting the control signal of the VCO. In order for the correction to effectively cancel a tendency to change, the VCO signal must have a predictable phase over the length of time that is needed to measure the signal and apply any necessary correction. This is clearly necessary so that the correction that is determined by the PLL is in fact still the proper correction a short time later when it actually takes effect. Typical VCOs have sufficient short-term stability that conventional PLLs rarely have a problem with loop delay issues. In that case the loop bandwidth may be chosen as a balance between being as small as possible (to reduce noise) while large enough to retain sufficient locking speed.

Considering the size of discrete components and the propagation speed of the various signals involved in the OPPL, there is a minimum possible loop delay that may be realized in practice. Ramos and Seeds [1] showed that for a given summed laser linewidth, it is possible to partially compensate for increased loop delay by increasing loop bandwidth. Alternatively, for a given delay time, increasing the loop bandwidth may enable operation of an OPLL with a larger summed laser linewidth. Increasing loop bandwidth does not permit delay to increase without limit. In fact, increasing bandwidth only permits longer delay in the case that the summed linewidth is already quite small, and it has been shown [2] that there is a maximum product of loop delay and bandwidth beyond which an OPLL becomes unstable.

A practical problem associated with increasing loop bandwidth is that for stable operation of any PLL, the loop bandwidth should not exceed 1% to 10% of the phase detector frequency (ƒ_{PD}). The upper end of this range (bandwidth˜0.1 ƒ_{PD}) may require the use of a high order loop filter to sufficiently isolate the error signal. Therefore, either a very high phase detector frequency is needed (˜100 times the loop bandwidth) or a high order loop filter is needed to allow operation of a phase detector at a lower frequency, closer to 10 times the loop bandwidth. The drawback of high order loop filters is that they tend to make a PLL unstable due to reduced phase margin, especially where high bandwidths are also involved.

Seregelyi et al. [3] use an analogue mixer as a phase detector to phase lock a pair of external cavity lasers (ECL) with the aid of a second control loop (a frequency discriminator) to assist in stabilizing the laser frequency. Aside from the added complexity of having two feedback loops, there are three disadvantages to this approach. One, which is admitted by Seregelyi, is that the frequency discriminator permits locking only at discrete frequencies. Ideally, the allowed frequencies would be closely spaced to provide high frequency resolution. This, however, reduces the capture range of the PLL since the loop will lock to the nearest frequency permitted by the discriminator. Thus the two competing goals (high resolution and large capture range) are mutually exclusive. The second disadvantage is that the PLL uses an analogue mixer for a phase detector. As a phase detector, an analogue mixer has the disadvantage of limited capture range, thus an extra control loop may be needed. Finally, the system still requires unusually narrow linewidth (ECL) semiconductor lasers. ECL lasers are not widely available in the marketplace, being a specialized device, whereas distributed feedback (DFB) lasers are available from many manufacturers. Additionally, ECL lasers that are available tend to be limited in power compared to DFB lasers.

The second prior art method for phase locking semiconductor lasers uses an optical delay line as a frequency discriminator combined with a PID (proportional-integral-derivative) controller [4]. This combination allows use of the more common DFB lasers and also allows continuous tuning through adjusting the length of the delay line, and may be considered an improvement over the method of Seregelyi in those respects. A major disadvantage is the need for an expensive optical delay line and a differential optical detector.

Other materials only consider locking solid state lasers (such as the Nd:YAG) or fibre lasers (such as the Er-doped DFB), either of which is comparatively easy compared to the challenge of locking semiconductor lasers, and is well known and commonly used within the field. One example [5] demonstrates using a commercially available source-locking frequency counter for this task.

### SUMMARY

In an OPLL embodying the principles of the invention, a control system is used to lock the optical frequency difference between two lasers to a stable reference electronic oscillator.

In another OPLL embodying the principles of the invention, a phase-locked loop is provided comprising a phase-frequency detector; first and second lasers; a local oscillator; and

a low pass filter; operably connected in a circuit comprising a feedback path.

In another OPLL embodying the principles of the invention, a phase-locked loop is provided comprising a phase-frequency detector; first and second lasers; a local oscillator; a pre-scaler and a low pass filter; operably connected in a circuit comprising a feedback path.

In another OPLL embodying the principles of the invention, a phase-locked loop is provided comprising a phase-frequency detector; first and second lasers; two local oscillators; a mixer and a low pass filter; operably connected in a circuit comprising a feedback path.

### BRIEF DESCRIPTION OF THE DRAWINGS

FIG. 1 is an OPLL embodying the principles of the invention;

FIG. 2 is an OPLL embodying the principles of the invention;

FIG. 3 is a Brillouin distributed sensor system comprising an OPLL embodying the principles of the invention; and

FIG. 4 is a coherent communication system comprising an OPLL embodying the principles of the invention.

### DETAILED DESCRIPTION

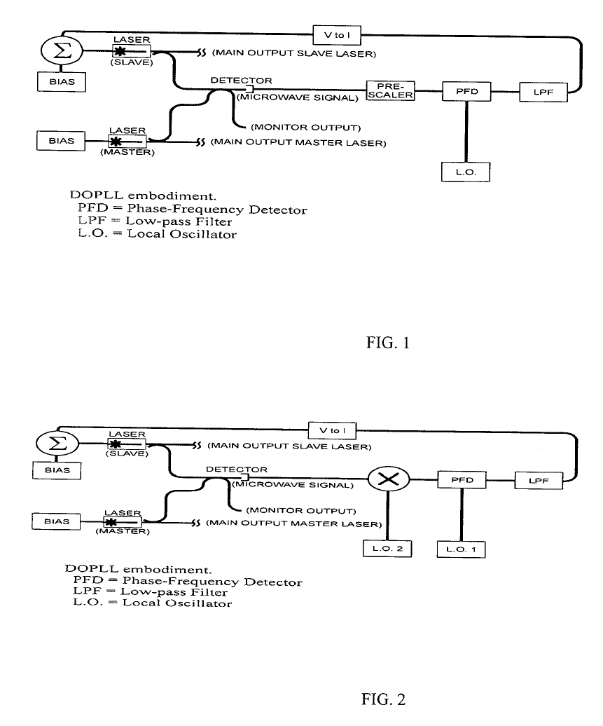

Referring to FIG. 1, in one embodiment, an OPLL embodying the principles of the invention comprises a master semiconductor laser and a slave semiconductor laser, a single tunable local oscillator (L.O.), a very high bandwidth (>2 GHz) digital phase-frequency detector (PFD) to compare the laser signal from each laser with the L.O.s, and a low pass filter (LPF), all operably connected in a circuit comprising a feedback path. As long as the incoming microwave signal at the PFD is less than or equal to the bandwidth of the phase-frequency detector (PFD), the signal can be phase-locked. For example, if the phase-frequency detector has a maximum frequency of operation of about 2 GHz, the incoming microwave signal must be at a frequency of <2 GHz in order to be phase locked. The incoming optical signal (between the coupler and detector) is the superposition of the optical signals of the master and slave lasers. After the detector there is a single microwave signal that is nominally a sine wave at the difference frequency between master and slave lasers.

Because the PFD runs at a high frequency, it is possible to use a wide bandwidth (˜4 MHz) loop filter as the LPF to enable operation with the master and slave moderately wide linewidth semiconductor lasers. The high frequency of PFD operation also implies short propagation delays through the phase frequency detector (PFD), avoiding excessive loop delay that would certainly be problematic if a lower PFD frequency were used. Propagation delay is further minimized by making all connections in the system as short as is practically possible. Although the loop filter, a low pass filter (LPF), has a wide bandwidth, it is less than 1% of the PFD frequency, allowing the use of simple low order filter as the low pass filter (LPF).

If the incoming microwave signal at the PFD is above the maximum frequency of operation of the PFD (for example, 2 GHz), the microwave signal can be scaled or divided down, using a frequency divider prescaler circuit (Pre-Scaler). For example, an N=8 prescaler enables an OPLL embodying the principles of the invention, in one embodiment, to generate signals up to about 16 GHz.

Referring to FIG. 2, in one embodiment, an OPLL embodying the principles of the invention comprises a master semiconductor laser and a slave semiconductor laser first and second tunable local oscillators (L.O.1, L.O.2), a very high bandwidth (>2 GHz) digital phase-frequency detector (PFD) to compare the laser signal from each laser with the L.O.s, and a low pass filter (LPF), all operably connected in a circuit comprising a feedback path.

In another embodiment, an OPLL embodying the principles of the invention; uses a mixer circuit to downconvert the microwave signal. If a mixer is used, an additional stable local oscillator is required to drive the mixer.

OPLLs embodying the principles of the invention can use a variety of lasers. For example, in addition to semiconductor lasers, fibre lasers and solid state lasers can be used. Although very narrow linewidth solid state lasers and special ECL semiconductor lasers can be used, conventional wide linewidth DFB lasers can also be used and phase locked.

In an embodiment of an OPLL embodying the principles of the invention, the phase-frequency detector is such that it permits a suitably small propagation delay in the OPLL while at the same time providing a suitably large operating frequency in the OPLL.

In another embodiment of an OPLL embodying the principles of the invention, the phase frequency detector is such that a phase correction to the lasers being locked can be made within the coherence time of the lasers.

In a further embodiment of an OPLL embodying the principles of the invention, the low pass filter has a bandwidth that is wide enough to lock the lasers of the OPLL while at the same time having a suitably narrow bandwidth to keep noise in the OPLL within acceptable limits.

### EXAMPLES

Another embodiment of an OPLL which embodies the principles of the invention is optimized for a particular frequency of operation (11 GHz). At this frequency, a prescaler value of 8 is used to lock the lasers to a nominal 1.375 GHz tunable reference oscillator. The range of frequencies that can be generated is limited on the upper end by the phase detector, which is guaranteed to work at 2 GHz (but may work at higher frequencies). The maximum frequency is therefore around 16 GHz. The minimum frequency is limited by the bandwidth of the loop filter. In one embodiment of an OPLL which embodies the principles of the invention, the phase detector frequency is at least 10 to 100 times the loop bandwidth. If a filter with about 4 MHz bandwidth is used to maintain lock, the minimum phase detector frequency is therefore somewhere between 40 and about 400 MHz and so the minimum microwave frequency is about 8 times higher, or 320 MHz to 3.20 GHz. If a filter with about 1 MHz bandwidth is used to maintain lock, the minimum phase detector frequency is therefore somewhere between 10 and about 100 MHz and so the minimum microwave frequency is about 80 MHz to about 800 MHz.

Operation at lower frequencies is possible by reducing the prescaler divide ratio (or eliminating the prescaler entirely if the desired microwave frequency is ˜2 GHz or less) with a corresponding drop in maximum frequency. A usable range of frequencies is between 2000:400 and 2000:40, or 5-50:1. It is possible to operate an OPLL which embodies the principles of the invention over an even wider range of frequencies by having a suitable variable divide ratio prescaler, or by using a suitable switch to choose between several fixed prescaler values. The limitation on the high frequency side then becomes the bandwidth of the optical detector and the prescaler circuits. Currently available detectors with 40 to 60 GHz bandwidths can be used. Currently available prescalers such as those which operate at about 26 GHz can be used. It will be understood by those skilled in the art that circuits and PFDs with even higher frequencies can also be used, as they become available, in OPLLs embodying the principles of the invention.

The tuning resolution in an OPLL which embodies the principles of the invention, is limited only by the reference oscillator. Very high tuning resolution may be obtained with techniques such as direct digital synthesis to generate the tunable reference oscillator from a fixed frequency standard (such as a crystal oscillator).

An OPLL embodying the principles of the invention is also useful for implementing a widely tunable oscillator with an output that is available in both electrical and optical form. The oscillator may run at frequencies well below 1 GHz up to the maximum bandwidth of the photodetector and electronic components used. Currently available components easily reach an upper frequency of over 26 GHz but it will be understood by those skilled in the art that components supporting higher frequencies can be used as they become available. Such widely tunable oscillators find use in software defined radio.

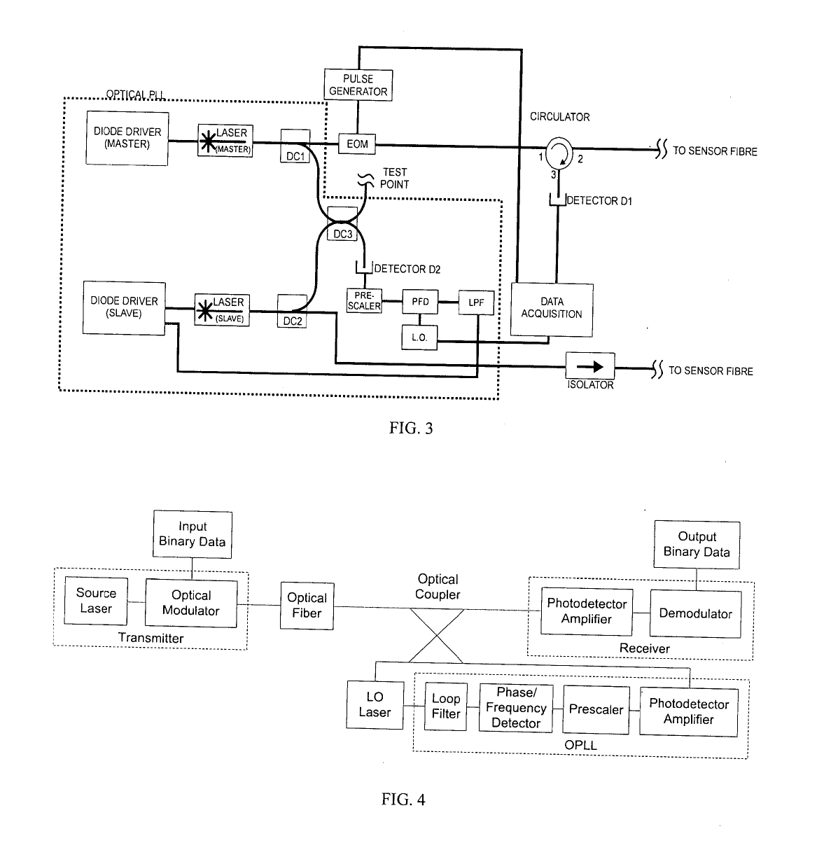

OPLLs which embody the principles of the invention, can be integrated in a Brillouin distributed sensor system of the type illustrated in FIG. 3 and in coherent communication systems of the type illustrated in FIG. 4. Examples of coherent communication systems in which an OPLL embodying the principles of the invention can be integrated are PSK, FSK, AM and QAM systems.

### REFERENCES

[1] R. T. Ramos and A. J. Seeds, “Delay, linewidth and Bandwidth limitations in optical phase-locked loop design,” Electronics Letters, 26 (6) 389-391 (1990).

[2] M. A. Grant, W. C. Michie and M. J. Fletcher, “The performance of optical phase locked loops in the presence of nonnegligible loop propagation delay,” Journal of Lightwave Technology, 5, pp. 592-597 (1987).

[3] J. S. Seregelyi and J. C. Belisle, “A discriminator-aided, optical phase-lock loop constructed from commercial components,” Proc. SPIE 5577, 407-412 (2004).

[4] X. Bao et al. “Distributed Brillouin sensor system based on DFB lasers using offset locking,” United States patent application no. 20080018903 (2008).

[5] A. W. Brown, M. DeMerchant, J. Smith, X. Bao, and T. W. Bremner, “Brillouin scattering based distributed sensors for structural applications,” Journal of Intelligent Material Systems and Structures, 10 (4), 340-349 (1999).

1. A phase-locked loop comprising:
a phase-frequency detector;
first and second lasers;
a local oscillator,
a detector and a low pass filter;
operably connected in a circuit comprising a feedback path, wherein the first and second lasers are in communication with the detector, the detector is in communication with the phase-frequency detector, the local oscillator is in communication with the phase-frequency detector, the phase-frequency detector is in communication with the low pass filter and the low pass filter is in communication with the second laser.

2. The loop of claim 1 wherein the low pass filter is the only low pass filter in the loop.

3. The loop of claim 1 wherein the lasers are selected from the group consisting of semiconductor lasers, fibre lasers and solid state lasers.

4. The loop of claim 3 where the lasers are DFB lasers.

5. The loop of claim 1 wherein the phase-frequency detector is selected to provide a suitably small propagation delay and a suitably wide operating frequency in the circuit.

6. The loop of claim 1 further comprising a prescaler, wherein the prescaler is in communication with the detector and the phase frequency detector.

7. The loop of claim 6 wherein the prescaler is switchable between two or more preset prescaler values.

8. The loop of claim 1 further comprising a mixer circuit and a second local oscillator wherein the mixer circuit is in communication with the detector and the phase frequency detector and the second local oscillator is in communication with the mixer circuit.

9. A Brillouin distributed sensor system comprising the loop of claim 1.

10. The system of claim 9 wherein the loop of claim 1 further comprises a prescaler, wherein the prescaler is in communication with the detector and the phase frequency detector.

11. A coherent communication system comprising the loop of claim 1.

12. The coherent communication system of claim 11 wherein the system is selected from the group consisting of a PSK system, an FSK system, ASK system and a QAM system.

13. The loop of claim 1 wherein the first laser is a master and the second laser is a slave.
